(19) United States
(12) Patent Application Publication
(10) Pub. No.: US 2009/0190257 A1
(43) Pub. Date: Jul. 30, 2009

(54) MAGNETIC HEAD AND METHOD OF MANUFACTURING THEREFOR

(75) Inventor: Sigeru Yamaguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/349,101

(22) Filed: Jan. 6, 2009

(30) Foreign Application Priority Data
Jan. 30, 2008 (JP) 2008-019043

(51) Int. Cl. G11B 5/265; B32B 37/02

(52) U.S. Cl. 360/121; 156/272.2; 205/122

(57) ABSTRACT

A magnetic head includes a magnetic pole for writing. The magnetic pole is formed by laminating a first magnetic layer and a second magnetic layer so as to sandwich a write gap on the magnetic pole end side. The second magnetic layer is formed to be laminated on the write gap in a region in which the write gap is provided. The second magnetic layer is laminated on an insulating layer via an adhesive layer in a region other than the write gap.

### CROSS-REFERENCE TO RELATED APPLICATION

This application is based upon and claims the benefit of priority of prior Japanese Patent Application No. 2008-19043, filed on Jan. 30, 2008, the entire contents of which are incorporated herein by reference.

### BACKGROUND

1. Field

The embodiment discussed herein is directed to a magnetic head capable of highly precisely setting a write gap of a write head, and to a method of manufacturing the magnetic head.

2. Description of the Related Art

In a write head of a magnetic head, a lower magnetic pole and an upper magnetic pole are formed in an arrangement to sandwich a write gap formed by an insulating layer of Al₂O₃, SiO₂ or the like.

FIG. 11 shows an arrangement in an air bearing surface (ABS surface), of a write gap 10, a lower magnetic pole 12, and an upper magnetic pole 14 which are formed in the write head. The upper magnetic pole 14 is formed to have a narrowed width on the air bearing surface. The narrowed width size of the magnetic pole portion becomes a core width (portion A in FIG. 11). The reason why the upper magnetic pole 14 is formed to have the narrowed width is to enable high density recording by concentrating a magnetic field for writing at the magnetic pole end as much as possible.

In the case where the upper magnetic pole 14 is formed by plating, a plating seed layer is formed on the surface of the write gap layer, and the upper magnetic pole 14 is formed by performing electrolytic plating using the plating seed layer as a plating power-supply layer. For example, when the upper magnetic pole 14 is formed by using NiFe, an NiFe film is first formed by sputtering. Next, the upper magnetic pole 14 is formed by using the NiFe film as a plating base. However, the adhesive property between the write gap layer formed of the insulating layer and the plating seed layer is low. Thus, a Ti (titanium) film, which is a non-magnetic metal and which has a good adhesive property with the write gap layer, is formed on the surface of the write gap layer. The plating seed layer is formed on the Ti film, and then the upper magnetic pole 14 is formed. FIG. 11 shows a conventional structure of a write head. The write gap 10, a Ti film 11, and a plating seed layer 15 are laminated and sandwiched between the lower magnetic pole 12 and the upper magnetic pole 14 (Japanese Patent Laid-Open Publication No. S61-137213).

As described above, in the conventional manufacturing process, the Ti film 11 is formed as an adhesive layer on the surface of the write gap layer so that the write gap layer is made to sufficiently adhere to the upper magnetic pole. However, when the Ti film is formed on the surface of the write gap layer, the film thickness of the Ti film directly influences the dimension of the write gap. For example, there arises a problem that the dimension of the write gap is varied by the variation in the film thickness of the Ti film 11. In the manufacture of a magnetic head, a number of magnetic heads are made on a ceramic wafer. Therefore, in the case where the Ti film and the like, is formed on the wafer, when the film thickness of the Ti film is varied in the surface of the wafer, there arises a problem that the dimension of the write gap is varied to thereby lower the manufacturing yield.

### SUMMARY

Accordingly, it is an object of the embodiment to provide a magnetic head including a write head which is capable of improving manufacturing yield and performing highly precise writing by suppressing variation in the write gap dimension without impairing the adhesive property between the write gap and the upper magnetic pole, and to provide a method of manufacturing the magnetic head.

A magnetic head includes a magnetic pole for writing. The magnetic pole is formed by laminating a first magnetic layer and a second magnetic layer so as to sandwich a write gap on the magnetic pole end side. The second magnetic layer is formed to be laminated on the write gap in a region in which the write gap is provided. The second magnetic layer is laminated on an insulating layer via an adhesive layer in a region other than the write gap.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The embodiments will be explained with reference to the accompanying drawings.

FIG. 1A is a sectional view taken along line A-A in FIG. 1B;

FIG. 1B is a plan view showing a manufacturing process of a magnetic head when an upper magnetic pole is formed on an insulating layer;

FIG. 2A is a sectional view taken along line A-A in FIG. 2B;

FIG. 2B is a plan view showing a manufacturing process of the magnetic head at the time when before a Ti film as an adhesive layer is formed on the surface of the insulating layer, a second region near a position used as an air bearing surface after the processing is covered by a resist;

FIG. 3A is a sectional view taken along line A-A in FIG. 3B;

FIG. 3B is a plan view showing a manufacturing process of the magnetic head at the time when the Ti film serving as the adhesive layer with the insulating layer is formed on the surface of a work by sputtering;

FIG. 4A is a sectional view taken along line A-A in FIG. 4B;

FIG. 4B is a plan view showing a manufacturing process of the magnetic head at the time of lifting off the resist;

FIG. 5A is a sectional view taken along line A-A in FIG. 5B;

FIG. 5B is a plan view showing a manufacturing process of the magnetic head at the time when after the resist and the Ti film adhered to the resist are removed by the lift-off process, a plating seed layer is formed on the work surface;

FIG. 6A is a sectional view taken along line A-A in FIG. 6B;

FIG. 6B is a plan view showing a manufacturing process of the magnetic head at the time when a resist pattern is formed in such a manner that the work surface is covered by a resist, that the resist is exposed and developed according to the planar shape of the upper magnetic pole, and that the resist of a portion corresponding a first region is removed;

FIG. 7A is a sectional view taken along line A-A in FIG. 7B;

FIG. 7B is a plan view showing a manufacturing process of the magnetic head when a second magnetic layer serving as the upper magnetic pole is formed by electrolytic plating using the plating seed layer as a plating power-supply layer;

FIG. 8A is a sectional view taken along line A-A in FIG. 8B;

FIG. 8B is a plan view showing a manufacturing process of the magnetic head at the time when after the second magnetic layer is formed, the resist pattern is removed;

FIG. 8C shows a sectional view in the region outside the second region;

FIG. 9A is a sectional view taken along line A-A in FIG. 9B;

FIG. 9B is a plan view showing a manufacturing process of the magnetic head at the time when a write head is formed in such a manner that in the state shown in FIG. 8B, a lower magnetic pole 12 as a first magnetic layer is milled to the middle in the thickness direction by being subjected to ion milling using the second magnetic layer as a mask, so as to shape the lower magnetic pole, a write gap, and the upper magnetic pole;

FIG. 10 is a sectional view showing a structure of the magnetic head; and

FIG. 11 is a sectional view showing a structure of a conventional write head.

### DETAILED DESCRIPTION OF THE PREFERRED EMBODIMENT

Embodiment of the present invention will be described in detail below with reference to the accompanying drawings.

In the following, there will be described a method of manufacturing a magnetic head according to an embodiment of the present invention.

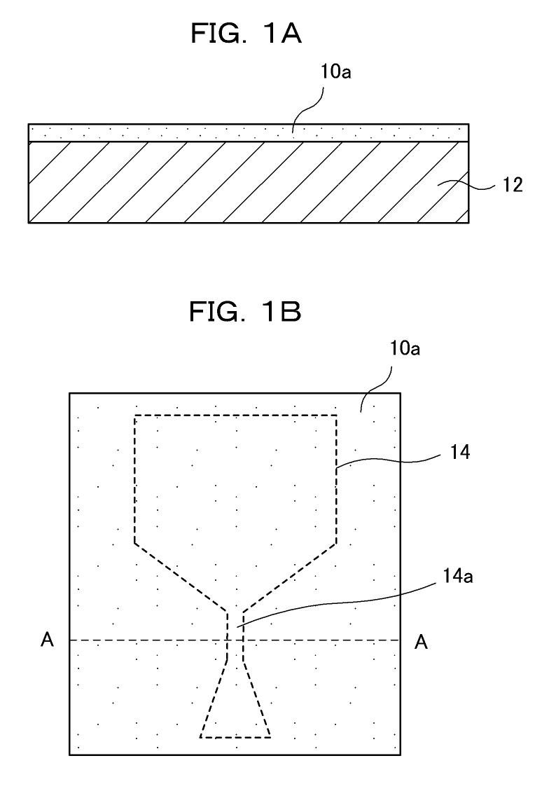

FIG. 1A to FIG. 9A show sectional views taken along an air bearing surface (ABS surface) position of a write head in respective manufacturing processes of a magnetic head. FIG. 1B to FIG. 9B show plan views of the portion of the write head in the respective manufacturing processes.

FIG. 1A shows a state where a lower magnetic pole 12 of a write head is formed as a first magnetic layer on the surface of a work, and where an insulating layer 10a is formed on the surface of the lower magnetic pole 12. The lower magnetic pole 12 is formed of a soft magnetic material, such as NiFe. In the present embodiment, the lower magnetic pole 12 is formed by using a plating method. It is of course possible to form the lower magnetic pole 12 by other film forming methods, such as a sputtering method.

The insulating layer 10a configures a write gap. The insulating layer 10a is formed by sputtering an insulating material, such as Al₂O₃ or SiO₂, to a targeted thickness (about 0.3 μm) of the write gap. The insulating layer 10a is formed so as to adhere to the entire work surface. FIG. 1B shows a state where the insulating layer 10a is formed so as to adhere to the work surface.

FIG. 1B shows a plan view of an upper magnetic pole 14 formed on the insulating layer 10a. In FIG. 1B, the position along the line A-A shows an air bearing surface of the magnetic head. The upper magnetic pole 14 is formed into a shape having a width narrowed around the air bearing surface. The lower magnetic pole 12 is formed into a wide plate-like shape around the position of the air bearing surface.

In the work (wafer) in which the magnetic head is formed, structures including the lower magnetic poles 12 and the upper magnetic poles 14, and the like, are formed in the same pattern, and are arranged while being aligned in longitudinal and lateral directions.

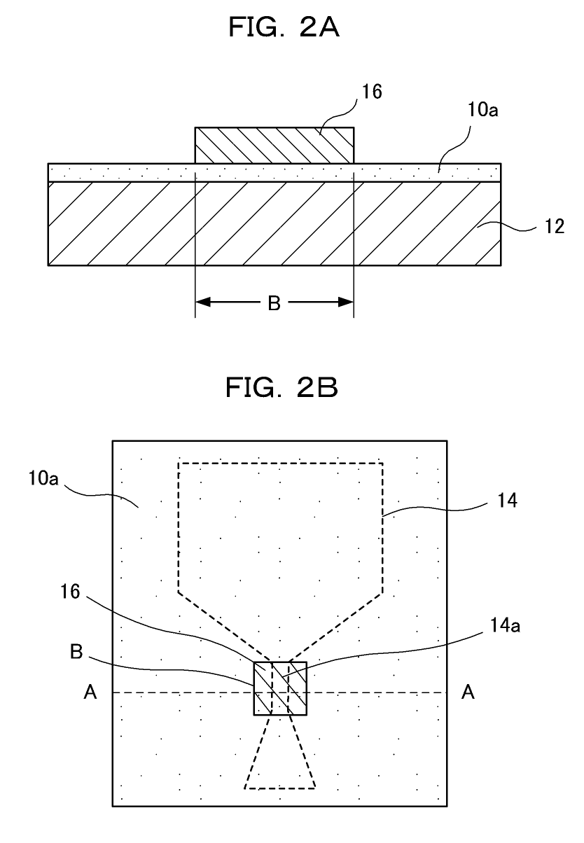

FIG. 2A and FIG. 2B show a process in which before a Ti film 11 serving as an adhesive layer is formed on the surface of the insulating layer 10a, a second region (portion B in FIGS. 2A and 2B) close to the position to be used as the air bearing surface after the processing is covered by a resist 16. The second region is set so as to include a first region in which the upper magnetic pole 14 is formed. Specifically, the second region is set so as to include the region in which the magnetic pole 14a of the upper magnetic pole 14 is formed. The width dimension of the resist 16 is set larger than that of the magnetic pole 14a so that the region forming the magnetic pole 14a is covered by the resist 16 even when the position of the resist 16 is deviated. Further, the resist 16 is arranged so as to stride over (cross) the air bearing surface (the position of line A-A).

The resist 16 is formed in such a manner that a resist material is coated on the work surface, and that the resist material is exposed and developed to make the second region covered by the resist 16. FIG. 2A shows a state where the resist 16 is made to adhere to the surface of the insulating layer 10a, as a cross sectional structure taken along line A-A in FIG. 2B. The resist 16 is formed so as to be patterned in the above described pattern, for each unit of the magnetic head on the work surface.

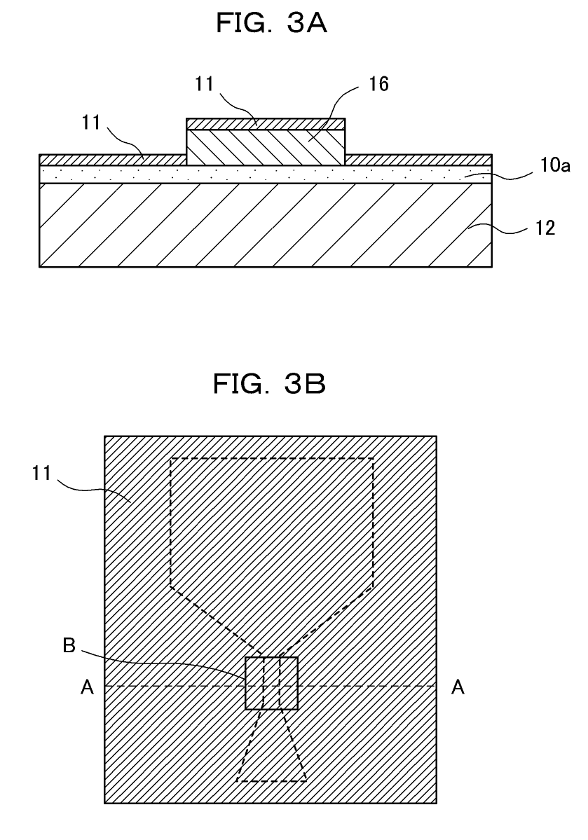

FIG. 3A and FIG. 3B show a state where the Ti film 11 is formed as the adhesive layer with the insulating layer 10a on the work surface by sputtering. In the present embodiment, the Ti film 11 is formed to have a film thickness of about 50 angstroms. As shown in FIG. 3B, the entire work surface is covered by the Ti film 11. The portion of the work surface, to which portion the resist 16 is made to adhere, is formed into a stepped shape in the state where the Ti film 11 is formed (FIG. 3A).

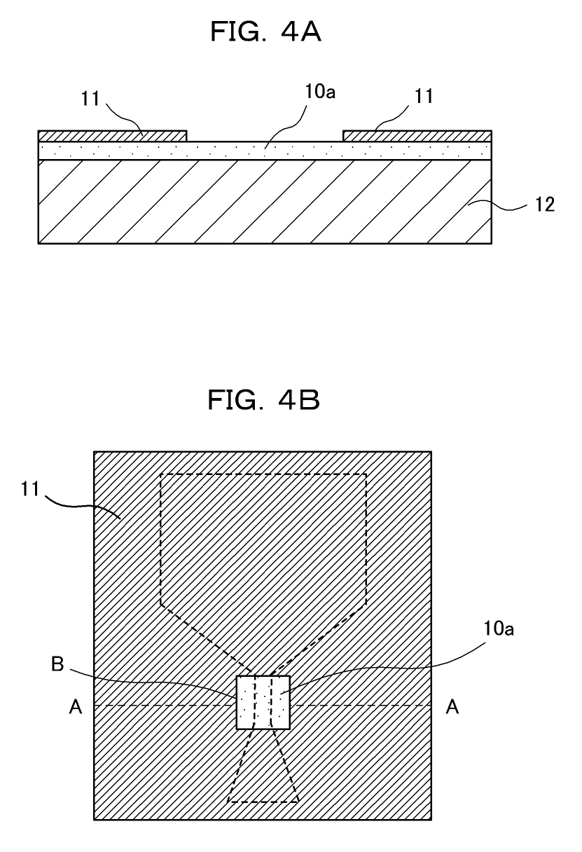

FIG. 4A and FIG. 4B show a process of lifting off the resist 16. The lift-off process is a process in which only the resist 16 is selectively removed. The resist 16 is removed by using an etching solution which selectively dissolves the resist 16. When the resist 16 is removed, the Ti film 11 adhering to the surface of the resist 16 is also removed together with the resist 16. Thereby, the portion of the work surface, which portion was covered by the resist 16, is exposed, and the lower insulating layer 10a is exposed in the second region B.

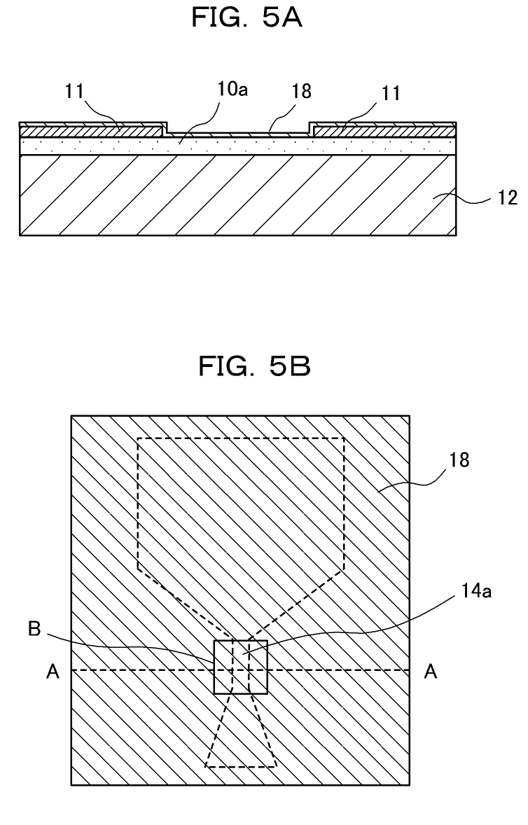

FIG. 5A and FIG. 5B show a state where after the resist 16 and the Ti film 11 adhering to the resist 16 are removed by the lift-off process, a plating seed layer 18 is formed on the work surface. In the present embodiment, the plating seed layer 18 is formed by sputtering NiFe. The film thickness of the plating seed layer is about 200 angstroms. As shown in FIG. 5B, the plating seed layer 18 is formed so as to adhere to the entire work surface. In the second region B in which the resist 16 is removed, the plating seed layer 18 is formed so as to adhere to the surface of the insulating layer 10a. In the region other than the second region B, the plating seed layer 18 is formed on the Ti film 11.

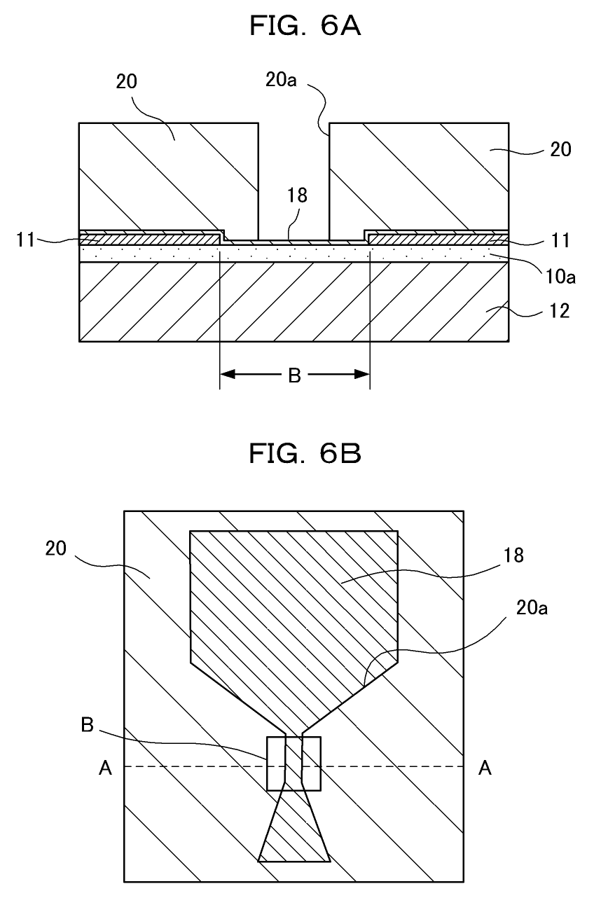

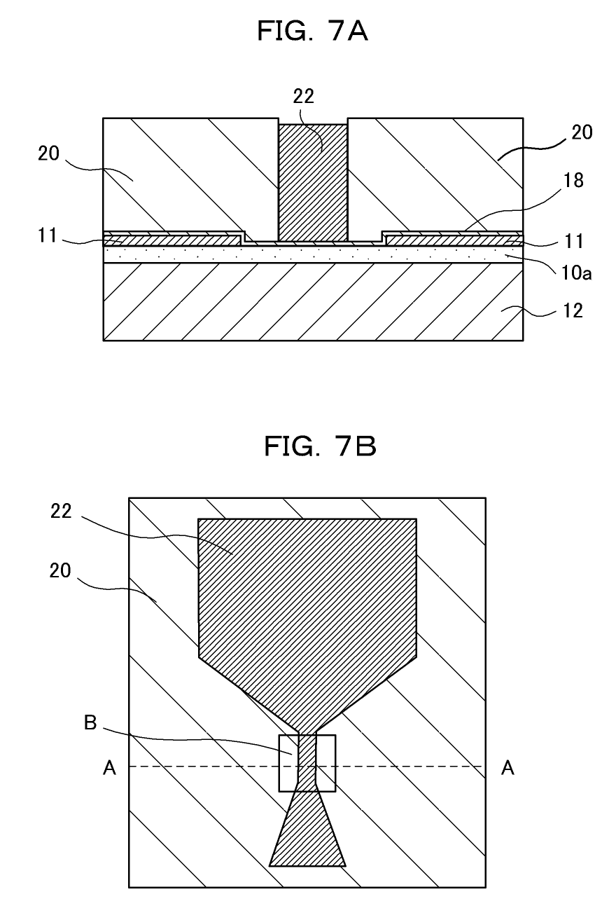

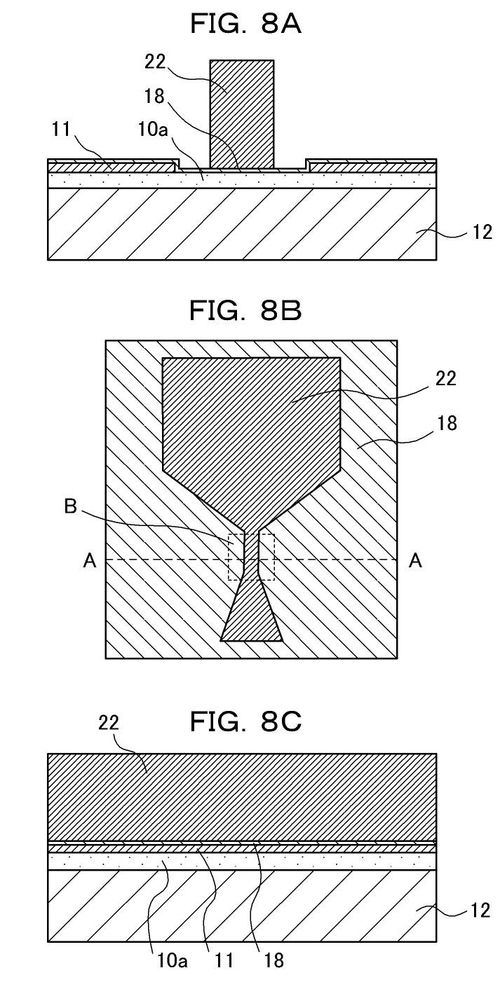

FIG. 6A, FIG. 6B, FIG. 7A, FIG. 7B, FIG. 8A and FIG. 8B show a process of forming the upper magnetic pole 14 in a predetermined pattern by using a plating method. FIG. 6A and FIG. 6B show a state where a resist pattern 20 is formed in such a manner that the work surface is covered by a resist, that the resist is exposed and developed according to the planar shape (the first region) of the upper magnetic pole 14, and that the resist corresponding to the first region is removed. The plating seed layer 18 is exposed on the surface in the first region of the resist pattern 20, that is, in a portion 20a in which the upper magnetic pole 14 is to be formed (FIG. 6B).

Note that the plating seed layer 18 is formed on the Ti film 11. However, in the portion of the first region, in which the plating seed layer 18 is exposed on the surface and which overlaps with the second region B, the Ti film 11 is not formed on the underlayer, but the plating seed layer 18 is directly formed so as to adhere to the insulating layer 10a (FIG. 6A).

FIG. 7A and FIG. 7B show a state where a second magnetic layer 22 to be used as the upper magnetic pole 14 is formed by electrolytic plating using the plating seed layer 18 as a plating power-supply layer. The second magnetic layer 22 is formed by raising the plating in the first region of the work surface, in which region the plating seed layer 18 is exposed. The second magnetic layer 22 is formed of a soft magnetic material, such as NiFe.

FIG. 7A shows the state where the second magnetic layer 22 is formed, as a cross-sectional structure taken along the air bearing surface position (position of the line A-A). At the air bearing surface position, the second magnetic layer 22 is formed so as to be laminated on the insulating layer 10a and the plating seed layer 18. On the other hand, the Ti film 11 is formed on the insulating layer 10a in the region outside the second region B, and the second magnetic layer 22 is formed on the plating seed layer 18 laminated on the Ti film 11.

FIG. 8A and FIG. 8B show a state where after the formation of the second magnetic layer 22, the resist pattern 20 is removed. When the resist pattern 20 is removed, the plating seed layer 18 of the portion covered by the resist pattern 20 is exposed on the work surface.

FIG. 8A shows a cross-sectional structure taken along the air bearing surface. FIG. 8C shows a cross sectional structure in the region outside the second region. In the second region, the laminated structure including the second magnetic layer 22 on the lower magnetic pole 12 is a three-layer structure formed of the insulating layer 10a, the plating seed layer 18, and the second magnetic layer 22 (FIG. 8A). On the other hand, in the region outside the second region, the laminated structure including the second magnetic layer 22 on the lower magnetic pole 12 is a four layer structure formed of the insulating layer 10a, the Ti film 11, the plating seed layer 18, and the second magnetic layer 22 (FIG. 8C).

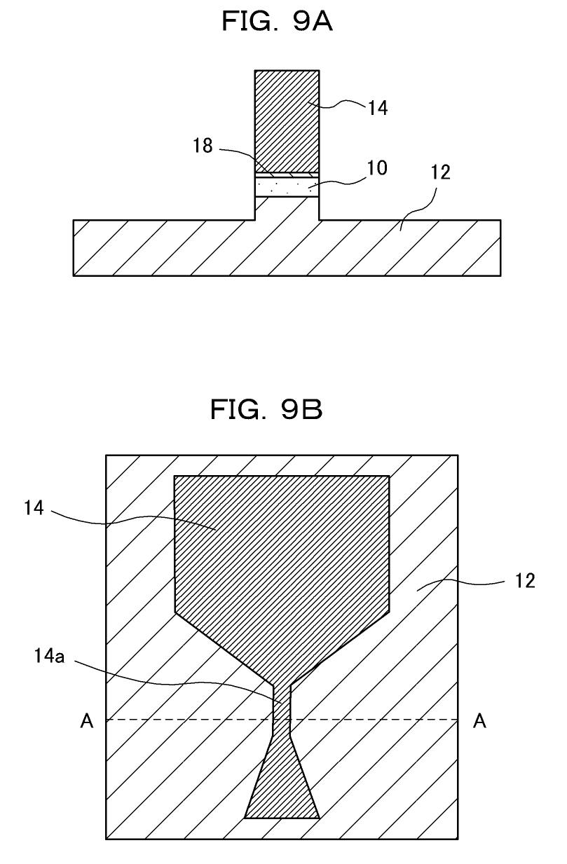

FIG. 9A and FIG. 9B show a state where the write head is formed in such a manner that in the state shown in FIG. 8A and FIG. 8B, the lower magnetic pole 12 as the first magnetic layer is milled to the middle in the thickness direction by being subjected to ion milling using the second magnetic layer 22 as a mask, so as to shape the lower magnetic pole 12, the write gap 10, and the upper magnetic pole 14.

According to the method of manufacturing the magnetic head of the present embodiment, the write head is formed to have a structure in which at the position of the air bearing surface (ABS surface), the write gap 10 made of the insulating layer 10a and the plating seed layer 18 are laminated on the lower magnetic pole 12, and in which the upper magnetic pole 14 is laminated on the plating seed layer 18. That is, at the position of the magnetic pole end of the upper magnetic pole 14, the upper magnetic pole 14 is formed without the Ti film as the adhesive layer being formed on the write gap 10.

In the conventional magnetic head, the Ti film 11 as the adhesive layer is formed on the write gap 10. Therefore, the dimension of the write gap is also varied by the variation in the film thickness of the Ti film 11. According to the method of the present invention, since the write gap is formed regardless of the Ti film, the write gap can be highly precisely formed as compared with the conventional method.

In the method according to the present invention, the Ti film 11 is not formed only in the region (the second region) close to the air bearing surface of the upper magnetic pole 14. However, in the region outside the second region, the Ti film 11 is formed similarly to the conventional process, and the Ti film 11 is formed as the underlayer of the plating seed layer 18 in substantially the whole region of the upper magnetic pole 14. Therefore, the adhesive property between the upper magnetic pole 14 and the write gap layer is sufficiently secured as a whole, and the problem about the adhesive property between the upper magnetic pole 14 and the write gap layer is also eliminated.

Note that in the present embodiment, the second magnetic layer 22 is formed on the plating seed layer 18 by plating, but the second magnetic layer can also be formed by using a film forming method, such as sputtering, without forming the plating seed layer 18.

(Structure of Magnetic Head)

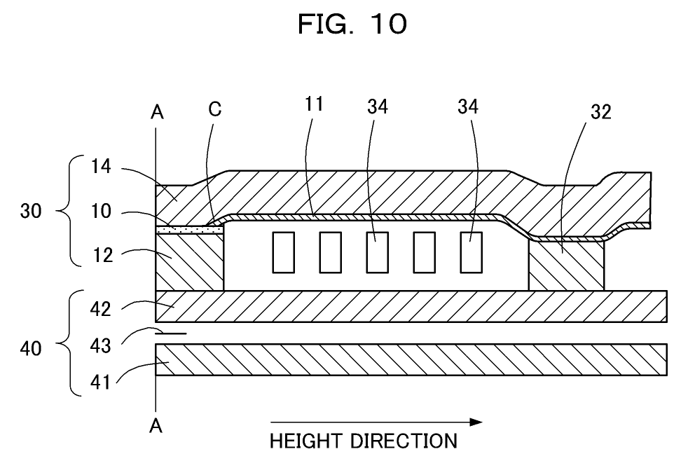

FIG. 10 shows a configuration example of a magnetic head in which the lower magnetic pole 12 and the upper magnetic pole 14 are arranged so as to sandwich the above described write gap 10 therebetween. This magnetic head is a magnetic head for so-called longitudinal recording.

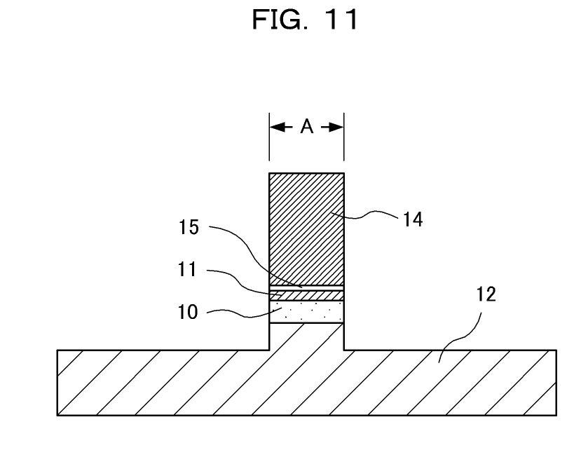

FIG. 11 shows a sectional view obtained by cutting off the structure of the magnetic head at a cross section which is perpendicular to the air bearing surface (line A-A in FIG. 10) and which passes through the center of the core width. The magnetic head is configured by a write head 30 (FIG. 10) for recording information on a recording medium, and a read head 40 for reading information recorded on the recording medium.

The write head 30 includes the lower magnetic pole 12, the write gap 10, and the upper magnetic pole 14. The lower magnetic pole 12 and the upper magnetic pole 14 are connected to each other by a back gap section 32 on the height direction side. Coils 34 are wound around the back gap section 32.

The read head 40 includes a lower shield layer 41, an upper shield layer 42, and a read element 43. In FIG. 10, respective interlayers are formed by a nonmagnetic insulator, such as an alumina.

As described above, in the magnetic head according to the present embodiment, the upper magnetic pole 14 is formed without the Ti film being formed in the region close to the air bearing surface. The Ti film 11 is formed as the adhesive layer on the surface of the insulating layer on the height direction side from the write gap 10 (on the height direction side from the zero throat position C). A plating seed layer (not shown) is formed on the Ti film 11, and the second magnetic layer serving as the upper magnetic pole 14 is formed via the Ti film 11.

Therefore, the dimension of the write gap 10 can be precisely defined only by the thickness of the insulating layer 10a. On the other hand, the adhesive property between the upper magnetic pole 14 and the insulating layer can be sufficiently secured by the interposition of the Ti film 11.

Note that in the present embodiment, the structure of the magnetic head according to the present invention is applied to a magnetic head for longitudinal recording, but of course, the structure of the magnetic head and the method of manufacturing the magnetic head, according to the present invention, can also be applied to a magnetic head for perpendicular recording.

According to the magnetic head and the method of manufacturing the magnetic head, according to the present invention, since there is no adhesive layer between the write gap and the second magnetic layer, it is possible to precisely define the dimension of the write gap by eliminating the variation in the thickness of the adhesive layer. Further, in the region other than the region in which the write gap is formed, the second magnetic layer is laminated on the adhesive layer, and hence the second magnetic layer and the insulating layer are made to surely adhere to each other. As a result, it is possible to secure the reliability of the magnetic head as a whole.

The order in which the embodiments have been described does not indicate superiority and inferiority of one embodiment over another. Although the embodiments of the present inventions have been described in detail, it should be understood that the various changes, substitutions, and alterations could be made hereto without departing from the spirit and scope of the invention.

What is claimed is:

1. A method of manufacturing a magnetic head including a magnetic pole for writing, comprising:
a step of successively laminating a first magnetic layer and an insulating layer on a surface of a work in which the magnetic head is formed;
a step of forming a resist in a second region which includes a first region with the magnetic pole formed therein and which is close to a position to be used as an air bearing surface after processing;
a step of forming an adhesive layer on the insulating layer and the resist;
a step of removing the resist and the adhesive layer on the resist;
a step of applying a resist material on the surface of the work and forming a resist pattern by removing the resist material according to the pattern of the first region;
a magnetic pole forming step of forming a second magnetic layer in the first region; and
a step of ion milling the adhesive layer, the insulating layer, and the first magnetic layer to a middle position in the thickness direction after removing the resist by using the second magnetic layer as a mask.

2. The method of manufacturing the magnetic head according to claim 1,
wherein the magnetic pole forming step comprises:
a step of forming a plating seed layer on the surface of the work after the resist and the adhesive layer are removed;
a step of forming the resist pattern on the surface of the work on which the plating seed layer is formed; and
a step of forming the second magnetic layer by the electrolytic plating using the plating seed layer as a plating power-supply layer.

3. The method of manufacturing the magnetic head according to one of claim 1,
wherein in the step of forming the resist in the second region, the width of the resist is larger than the width of the first region.

4. The method of manufacturing the magnetic head according to one of claim 2,
wherein in the step of forming the resist in the second region, the width of the resist is larger than the width of the first region.

5. The method of manufacturing the magnetic head according to one of claim 1,
wherein a Ti film is formed as the adhesive layer.

6. The method of manufacturing the magnetic head according to one of claim 2,
wherein a Ti film is formed as the adhesive layer.

7. The method of manufacturing the magnetic head according to one of claim 3,
wherein a Ti film is formed as the adhesive layer.

8. The method of manufacturing the magnetic head according to one of claim 4,
wherein a Ti film is formed as the adhesive layer.

9. A magnetic head including a magnetic pole for writing which is formed by laminating a first magnetic layer and a second magnetic layer so as to sandwich a write gap on the magnetic pole end side,
wherein the second magnetic layer is formed to be laminated on the write gap in a region in which the write gap is provided, and the second magnetic layer is laminated on an insulating layer via an adhesive layer in a region other than the write gap.

10. The magnetic head according to claim 9,
wherein the second magnetic layer is formed by plating on a plating seed layer formed on the write gap layer in the region in which the write gap is provided, and the second magnetic layer is formed by plating on a plating seed layer formed on the adhesive layer in the region other than the write gap.

11. The magnetic head according to one of claim 9,
wherein the adhesive layer is a Ti film.

12. The magnetic head according to one of claim 10,
wherein the adhesive layer is a Ti film.
